(19) United States
(12) Patent Application Publication
(10) Pub. No.: US 2019/0048867 A1
(43) Pub. Date: Feb. 14, 2019

(54) HYDRAULIC CONTROL DEVICE

(71) Applicant: HONDA MOTOR CO., LTD., Tokyo (JP)

(72) Inventors: Masamichi Harada, Wako-shi (JP); Kyohei Sakagami, Wako-shi (JP)

(21) Appl. No.: 16/056,576

(22) Filed: Aug. 7, 2018

(30) Foreign Application Priority Data
Aug. 10, 2017 (JP) 2017-155237

(51) Int. Cl. F04B 49/02; F16H 61/00; F15B 11/17; H02P 1/16

(52) U.S. Cl. CPC F04B 49/022; F16H 61/0031; F16H 59/72; H02P 1/16; F15B 11/17

(57) ABSTRACT

In a control unit of a hydraulic control device, when supply is switched to supply of first oil from a first pump to a continuously variable transmission mechanism through a check valve, a motor controller decreases a rotation number of a motor or stops the motor. The motor controller starts the motor only in a circumstance where an influence of an overshoot on a pressure (line pressure, pulley pressure) of oil that is supplied to the continuously variable transmission mechanism is small.

### CROSS-REFERENCE TO RELATED APPLICATION

This application is based upon and claims the benefit of priority from Japanese Patent Application No. 2017-155237 filed on Aug. 10, 2017, the contents of which are incorporated herein by reference.

### BACKGROUND OF THE INVENTION

### Field of the Invention

The present invention relates to a hydraulic control device that has, between a first pump and a hydraulic operation unit, a second pump and a check valve connected in parallel, and that supplies first oil from the first pump to the hydraulic operation unit through the check valve, or pressurizes the first oil with the second pump and supplies the first oil that has been pressurized to the hydraulic operation unit as second oil.

### Description of the Related Art

For example, Japanese Laid-Open Patent Publication No. 2015-200369 discloses a hydraulic control device in a transmission of a vehicle that has, between a first pump (mechanical pump) and a hydraulic operation unit of the transmission, a second pump (electric pump) that is operated by driving of a motor and a check valve connected in parallel. In this case, when an engine is started, first of all, first oil is supplied from the first pump to the hydraulic operation unit through the check valve. After that, the second pump is driven by the driving of the motor to pressurize the first oil that is supplied from the first pump, and the first oil that is pressurized is supplied from the second pump to the hydraulic operation unit as second oil.

### SUMMARY OF THE INVENTION

Incidentally, by controlling the driving of the motor in accordance with the state of the vehicle to drive or stop the second pump, the supply of the first oil from the first pump to the hydraulic operation unit through the check valve and the supply of the second oil from the second pump to the hydraulic operation unit can be switched. However, if the motor in a stop state is started, an overshoot occurs in a rotation of the motor, so that a rotation number of the second pump driven by the motor suddenly increases. As a result, a pressure of oil supplied to the hydraulic operation unit varies and the state of the vehicle may change. In addition, there is a concern that a rush current may occur due to the overshoot, and the rush current may flow to an electronic circuit included in a driving part of the motor. Therefore, it is preferable that the number of times that the motor is started be reduced as much as possible.

The present invention is an improvement of the hydraulic control device according to Japanese Laid-Open Patent Publication No. 2015-200369, and an object is to provide a hydraulic control device that can avoid the change of the state of the vehicle and the generation of a rush current by reducing the number of times of starting the second pump as much as possible.

The present invention relates to a hydraulic control device including, between a first pump and a hydraulic operation unit of a transmission, a second pump driven by a motor and a check valve connected in parallel and configured to supply first oil from the first pump to the hydraulic operation unit through the check valve, or pressurize the first oil that is supplied from the first pump with the second pump and supply the first oil that has been pressurized to the hydraulic operation unit as second oil.

To achieve the above object, the hydraulic control device includes a motor controller configured to decrease a rotation number of the motor or stop the motor when supply of the second oil from the second pump to the hydraulic operation unit is switched to supply of the first oil from the first pump to the hydraulic operation unit through the check valve.

Then, the motor controller is configured to, in a case where an overshoot occurs in a rotation of the motor when the motor in a stop state is started, start the motor only in a circumstance where an influence of the overshoot on a pressure of oil that is supplied to the hydraulic operation unit is small.

Thus, when the motor is in a low-rotation state and the supply of the first oil from the first pump to the hydraulic control device through the check valve is switched to the supply of the second oil from the second pump to the hydraulic control device, the motor is just shifted from the low-rotation state to a high-rotation state. Therefore, the occurrence of the overshoot can be prevented.

On the other hand, in a circumstance where the motor should be stopped, the motor is started only when the influence of the overshoot is small. Thus, the influence of the overshoot can be minimized.

Therefore, in either of the case where the rotation number of the motor is decreased and the case where the motor is stopped, the number of times that the second pump is started can be reduced as much as possible and the change of the state of the vehicle and the generation of the rush current can be avoided.

Here, the hydraulic control device may further include a temperature acquisition unit configured to acquire a temperature of the first oil or the second oil, and a table configured to express a relation between a standby rotation number that is a rotation number after being decreased and the temperature. In this case, the motor controller is configured to specify the standby rotation number based on the temperature with reference to the table and decrease the rotation number of the motor to the standby rotation number.

Thus, hunting, that is, opening and closing of the check valve due to the second oil discharged from the second pump, can be prevented. As a result, the unintended increase of the power consumption of the motor and the second pump due to the hunting can be avoided.

The hydraulic control device may further include a start permission determination unit configured to permit the motor to start if the temperature is in a predetermined temperature range and the pressure of the oil that is supplied to the hydraulic operation unit is more than or equal to a predetermined pressure. Thus, the occurrence of the overshoot can be prevented effectively.

The circumstance where the influence of the overshoot is small is a circumstance where the vehicle including the transmission is in the stop state or a circumstance where a flow rate of the first oil supplied from the first pump to the hydraulic operation unit through the check valve is more than a flow rate of the second oil supplied from the second pump to the hydraulic operation unit. In either circumstance, the influence of the overshoot can be minimized. Note that the circumstance where the flow rate of the first oil is more than the flow rate of the second oil supplied from the second pump to the hydraulic operation unit is, for example, shift of the vehicle.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a structure diagram of a hydraulic control device according to the present embodiment;

FIG. 2 is an explanatory diagram expressing an example of the table in FIG. 1;

FIG. 3 is a timing chart of a hydraulic pressure and a rotation number of a second pump;

FIG. 4 is a state transition diagram expressing an operation of the hydraulic control device illustrated in FIG. 1;

FIG. 5 shows a test result that demonstrates a control limit of the second pump when the second pump is rotated in a low-rotation state;

FIG. 6 is a table expressing a relation between a lateral pressure of a driven pulley and an oil temperature;

FIG. 7 is a table expressing a relation between the lateral pressure of the driven pulley and the oil temperature;

FIG. 8 is a table expressing a relation between the lateral pressure of the driven pulley and the oil temperature; and

FIG. 9 is a flow chart expressing an operation of the hydraulic control device in FIG. 1.

### DESCRIPTION OF THE PREFERRED EMBODIMENTS

A preferred embodiment of a hydraulic control device according to the present invention will hereinafter be described in detail with reference to the attached drawings.

### [1. Structure of the Present Embodiment]

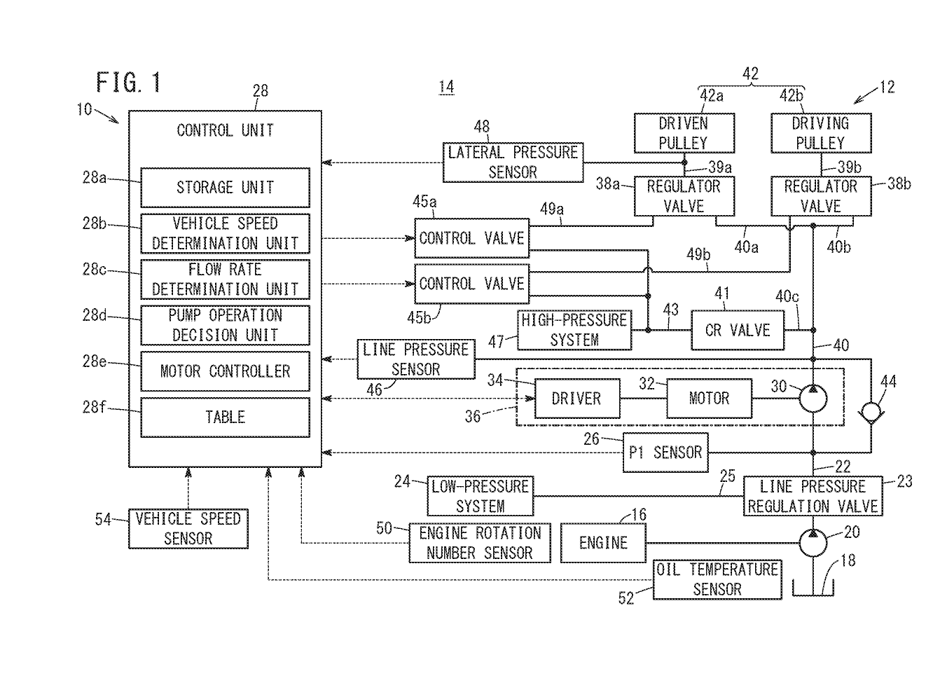

FIG. 1 is a structure diagram of a hydraulic control device 10 according to the present embodiment. The hydraulic control device 10 is used in, for example, a vehicle 14 including a transmission 12 corresponding to a continuously variable transmission (CVT).

The hydraulic control device 10 includes a first pump 20 that is driven by an engine 16 of the vehicle 14 and pumps up oil (hydraulic oil) stored in a reservoir 18 and transfers the oil with pressure. An output side of the first pump 20 is connected to an oil passage 22. The oil that is transferred with pressure from the first pump 20 flows as first oil in the oil passage 22. In the middle of the oil passage 22, a line pressure regulation valve 23 corresponding to a spool valve is provided.

To an oil passage 25 branched from the oil passage 22 through the line pressure regulation valve 23, a low-pressure system 24 of the transmission 12 is connected. To the low-pressure system 24, the first oil is supplied through the oil passage 25. The low-pressure system 24 is a hydraulic operation unit with a low pressure such as a torque converter to which the first oil is supplied. In the oil passage 22, an output pressure sensor (P1 sensor) 26 is disposed downstream of the line pressure regulation valve 23. The output pressure sensor 26 sequentially detects a pressure (the output pressure of the first pump 20) P1 of the first oil flowing in the oil passage 22, and sequentially outputs a detection signal expressing the detected output pressure P1 to a control unit 28 that will be described later. Note that in the present embodiment, the output pressure sensor 26 is not an essential component and can be omitted. On the downstream side in the oil passage 22, a second pump 30 that is smaller in capacity than the first pump 20 is connected.

The second pump 30 is an electric pump that is driven by a rotation of a motor 32 included in the vehicle 14, and that outputs second oil, or the first oil that is supplied through the oil passage 22. In this case, the second pump 30 can pressurize the first oil that is supplied, and transfer the first oil that has been pressurized as the second oil. The motor 32 rotates under a control of a driver 34. The driver 34 controls the driving of the motor 32 on the basis of a control signal supplied from the control unit 28, and moreover, sequentially outputs a signal expressing a driving state of the motor 32 (for example, a rotation number Nem of the motor 32 in accordance with a rotation number Nep of the second pump 30) to the control unit 28. The second pump 30, the motor 32, and the driver 34 form an electric pump unit 36.

An output side of the second pump 30 is connected to an oil passage 40. The oil passage 40 is branched into two oil passages 40a, 40b on the downstream side. The one oil passage 40a is connected through a regulator valve 38a and an oil passage 39a to a driven pulley 42a included in a continuously variable transmission mechanism 42 of the transmission 12. The other oil passage 40b is connected through a regulator valve 38b and an oil passage 39b to a driving pulley 42b included in the continuously variable transmission mechanism 42.

Between the two oil passages 22, 40, a check valve 44 and the second pump 30 are connected in parallel. The check valve 44 is a non-return valve provided to bypass the second pump 30, and allows the oil (first oil) to flow from the oil passage 22 disposed upstream to the oil passage 40 disposed downstream, and prevents the oil (second oil) from flowing from the oil passage 40 disposed downstream to the oil passage 22 disposed upstream.

A line pressure sensor 46 is disposed in the oil passage 40. The line pressure sensor 46 sequentially detects a pressure (line pressure) PH of the oil flowing in the oil passage 40, and sequentially outputs the detection signal expressing the detected line pressure PH to the control unit 28. In the oil passage 39a, a lateral pressure sensor 48 is disposed. The lateral pressure sensor 48 detects a pressure PDN of the oil to be supplied to the driven pulley 42a (a pulley pressure corresponding to the lateral pressure of the driven pulley 42a).

A CR valve 41 is connected to the downstream side of an oil passage 40c that is branched from the oil passage 40. The upstream side of the CR valve 41 is connected to the oil passage 40c, and the downstream side of the CR valve 41 is connected to two control valves 45a, 45b and a high-pressure system 47 of the transmission 12 through an oil passage 43. The CR valve 41 is a reducing valve. The CR valve 41 reduces the pressure of the oil (second oil) supplied from the oil passage 40c, and supplies the oil with the reduced pressure to the control valves 45a, 45b and the high-pressure system 47 through the oil passage 43.

The high-pressure system 47 is, for example, a forward clutch (not shown) included in the transmission 12, and the oil to be supplied to the high-pressure system 47 is higher in pressure than that supplied to the low-pressure system 24. Note that in the transmission 12, the oil with the highest pressure is supplied to the driven pulley 42a.

Each of the control valves 45a, 45b is a normally open electromagnetic valve with a solenoid. The control valves 45a, 45b are closed while the control signal (current signal) is supplied from the control unit 28 and current flows in the solenoid, and on the other hand, the control valves 45a, 45b are open while current does not flow in the solenoid.

The one control valve 45a is a solenoid valve for the driven pulley 42a, and when the valve is opened, the oil supplied from the CR valve 41 through the oil passage 43 is supplied to the regulator valve 38a through an oil passage 49a. The other control valve 45b is a solenoid valve for the driving pulley 42b, and when the valve is opened, the oil supplied from the CR valve 41 through the oil passage 43 is supplied to the regulator valve 38b through an oil passage 49b.

Therefore, the one regulator valve 38a uses the pressure of the oil supplied from the control valve 45a through the oil passage 49a, as a pilot pressure. If the line pressure PH of the oil supplied through the oil passages 40, 40a is more than or equal to a predetermined pressure, the regulator valve 38a is opened to supply the oil to the driven pulley 42a through the oil passage 39a. In addition, the other regulator valve 38b uses the pressure of the oil supplied from the control valve 45b through the oil passage 49b, as the pilot pressure. If the line pressure PH of the oil supplied through the oil passages 40, 40b is more than or equal to a predetermined pressure, the regulator valve 38b is opened to supply the oil to the driving pulley 42b through the oil passage 39b. The control valves 45a, 45b can regulate the pressure of the oil output to the oil passages 49a, 49b, respectively.

The line pressure regulation valve 23 is a spool valve. The line pressure regulation valve 23 normally connects between the first pump 20, and the second pump 30 and the check valve 44 through the oil passage 22, and by a displacement of the spool that is not shown, connects between the oil passage 22 and the oil passage 25 so that the first oil flows to the oil passage 25. Note that in the line pressure regulation valve 23, the pressure of the first oil flowing in the oil passage 25 may be lower than the output pressure P1 of the first oil flowing in the second pump 30 and the check valve 44 through the oil passage 22.

The hydraulic control device 10 further includes an engine rotation number sensor 50, an oil temperature sensor (temperature acquisition unit) 52, a vehicle speed sensor 54, and the control unit 28. The engine rotation number sensor 50 sequentially detects the engine rotation number New of the engine 16 in accordance with the rotation number Nmp of the first pump 20, and sequentially outputs the detection signal expressing the detected engine rotation number New (rotation number Nmp) to the control unit 28. The oil temperature sensor 52 sequentially detects a temperature (oil temperature) To of the first oil or the second oil, and sequentially outputs the detection signal expressing the detected oil temperature To to the control unit 28. The vehicle speed sensor 54 sequentially detects a vehicle speed V of the vehicle 14, and sequentially outputs the detection signal expressing the detected vehicle speed V to the control unit 28.

The control unit 28 is a microcomputer such as a CPU functioning as a transmission control unit (TCU) that controls the transmission 12 or an engine control unit (ECU) that controls the engine 16. The control unit 28 achieves functions of a vehicle speed determination unit 28b, a flow rate determination unit 28c, a pump operation decision unit (start permission determination unit) 28d, and a motor controller 28e by reading and executing programs stored in a storage unit 28a.

In the storage unit 28a, detection results based on the detection signals input from the above sensors to the control unit 28 are sequentially stored. In addition, processing results of each part of the control unit 28 are sequentially stored in the storage unit 28a.

The vehicle speed determination unit 28b determines whether the vehicle 14 is in a stop state (V=0) on the basis of the vehicle speed V from the vehicle speed sensor 54. The flow rate determination unit 28c calculates a flow rate of the second oil (a necessary flow rate Q) to be discharged from the second pump 30 that includes the flow rate of the oil needed in the driven pulley 42a, on the basis of the lateral pressure PDN of the driven pulley 42a from the lateral pressure sensor 48. Then, the flow rate determination unit 28c determines whether the necessary flow rate Q that is calculated is more than a predetermined threshold a (Q>a). Note that the threshold a is a minimum value of the flow rate when it is necessary that more oil is supplied to the continuously variable transmission mechanism 42 in shift, for example.

The pump operation decision unit 28d decides an operation state of the second pump 30 on the basis of the determination result of the vehicle speed determination unit 28b and the determination result of the flow rate determination unit 28c.

Specifically, if the vehicle speed determination unit 28b determines that the vehicle 14 is in the stop state or if the flow rate determination unit 28c determines that the necessary flow rate Q is more than the threshold a due to a shift operation of the transmission 12, the pump operation decision unit 28d permits the second pump 30 (the motor 32 that drives the second pump 30) to start.

In addition, if the oil temperature To is in a predetermined temperature range and the line pressure PH or the lateral pressure PDN is more than or equal to the predetermined pressure, the pump operation decision unit 28d permits the second pump 30 (the motor 32 that drives the second pump 30) to start.

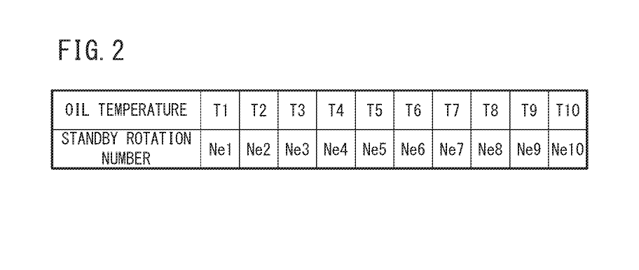

Furthermore, if the second pump 30 is operated in a low-rotation state while the first oil is supplied from the first pump 20 to the continuously variable transmission mechanism 42 through the check valve 44, the pump operation decision unit 28d decides a rotation number (standby rotation number) Nepi of the second pump 30 in the low-rotation state based on the oil temperature To with reference to a table 28f. FIG. 2 shows an example of the table 28f. The table 28f stores standby rotation numbers Ne1 to Ne10 (for example, Ne1<Ne2< . . . <Ne8=Ne9=Ne10) corresponding to oil temperatures T1 to T10 (T1<T2< . . . <T9<T10). Note that the second pump 30 is operated by the rotation of the motor 32; thus, the motor 32 rotates at the rotation number Nem based on the standby rotation number Nepi (Ne1 to Ne10).

The motor controller 28e generates the control signal for controlling the driving of the motor 32 on the basis of the process result of the pump operation decision unit 28d, and supplies the control signal to the driver 34.

### [2. Operation of the Present Embodiment]

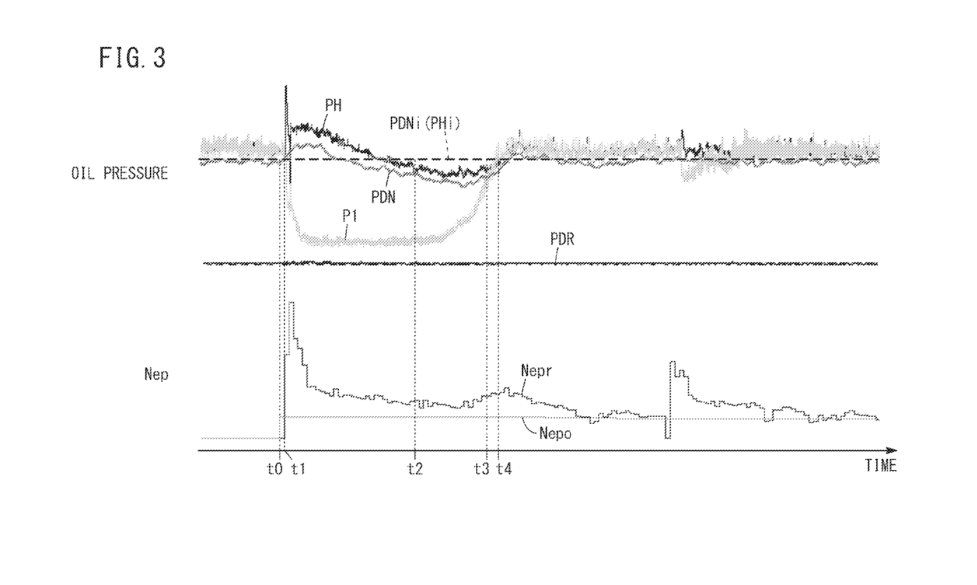

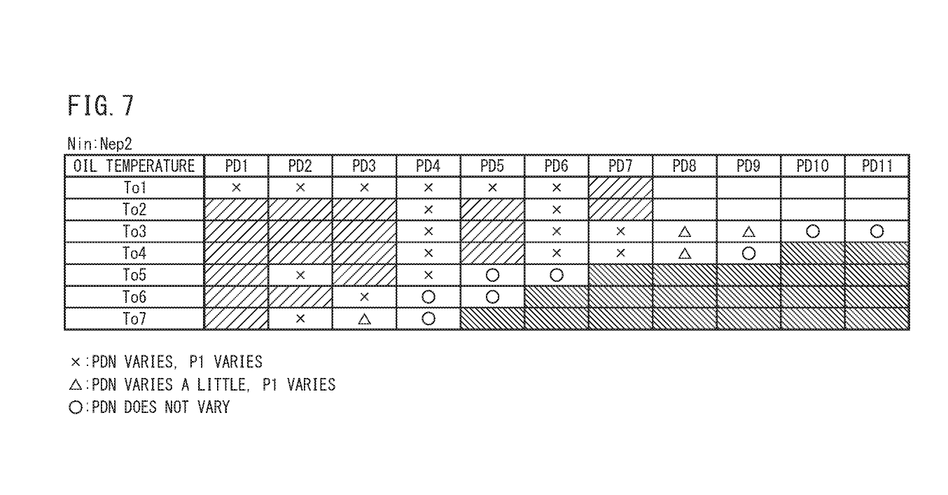

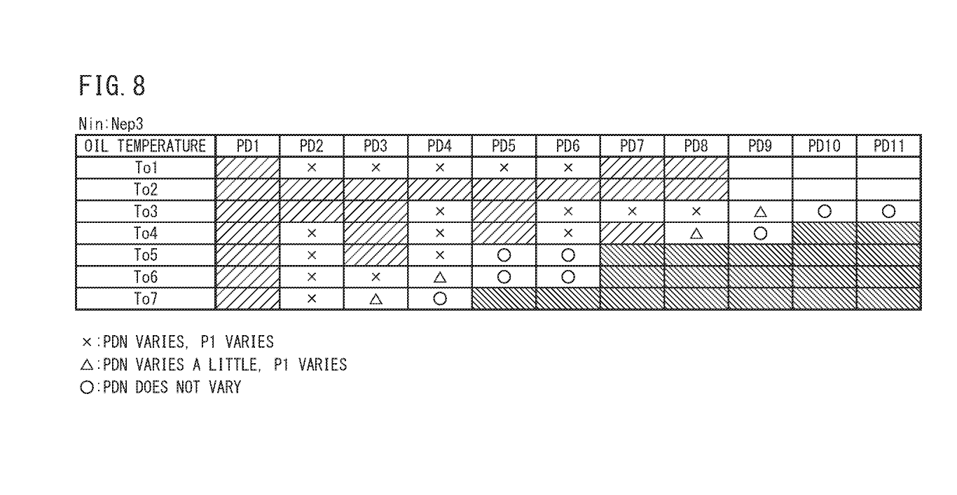

An operation of the hydraulic control device 10 according to the present embodiment with the above structure will be described with reference to FIG. 3 to FIG. 9. Here, description is given concerning a method in which the number of times that the second pump 30 is started is reduced as much as possible by controlling the driving of the motor 32 in accordance with the vehicle state of the vehicle 14, so as to avoid change of the state of the vehicle and generation of a rush current. The description of the operation is also given with reference to FIG. 1 and FIG. 2 as necessary.

### <2.1 Problem Regarding Starting of Second Pump 30>

Here, description is given concerning a problem in a case where the second pump 30 is started, with reference to the timing chart in FIG. 3.

If the first pump 20 is driven to supply the first oil to the continuously variable transmission mechanism 42 through the check valve 44 in a time band before a time point t0, the output pressure P1, the line pressure PH, the lateral pressure PDN of the driven pulley 42a, and a lateral pressure PDR of the driving pulley 42b maintain fixed values. In this case, the second pump 30 and the motor 32 are in the stop state.

At the time point t0, the motor controller 28e starts to supply to the driver 34, the control signal based on a predetermined rotation number (command value) Nepo. Then, the driver 34 starts the motor 32 to rotate the second pump 30 with the command value Nepo, on the basis of the control signal that is supplied.

However, when the motor 32 in the stop state is started at a time point t1, an overshoot occurs in the rotation of the motor 32 and the rotation number Nep of the second pump 30 driven by the motor 32 suddenly increases. Note that in FIG. 3, the actual rotation number Nep is indicated as Nepr in order to distinguish it from the command value Nepo.

Thus, a large amount of second oil temporarily flows from the second pump 30 to the continuously variable transmission mechanism 42 through the oil passage 40. As a result, the pressure (line pressure PH) of the oil supplied to the continuously variable transmission mechanism 42 varies and an overshoot occurs. In accordance with the variation of the line pressure PH, the lateral pressure PDN of the driven pulley 42a also varies.

Note that in FIG. 3, the dashed line indicates an ideal value PHi of the line pressure PH and an ideal value PDNi of the lateral pressure PDN. Since the lateral pressure PDR of the driving pulley 42b is much lower than the lateral pressure PDN of the driven pulley 42a, the lateral pressure PDR of the driving pulley 42b is hardly affected by the overshoot and maintains the fixed value.

As described above, a large amount of second oil flows in the oil passage 40; thus, the check valve 44 is closed to stop the flow of the first oil to the oil passage 40. As a result, after the time point t1, the pressure of the first oil (the output pressure P1) suddenly decreases from the line pressure PH.

After the overshoot occurs, the rotation number Nepr of the second pump 30 rapidly decreases as time elapses and the flow rate of the second oil discharged from the second pump 30 also decreases. As a result, the line pressure PH and the lateral pressure PDN decrease as time elapses.

After that, the rotation number Nepr of the second pump 30 becomes close to the command value Nepo and the flow rate of the second oil discharged from the second pump 30 decreases. Then, from a time point t2, the output pressure P1 gradually increases as time elapses. When the line pressure PH and the output pressure P1 become approximately the same at a time point t3, the check valve 44 is opened again after the time point t3. After a time point t4, the output pressure P1, the line pressure PH, and the lateral pressure PDN are maintained approximately at the ideal pressure values PHi, PDNi illustrated by the dashed line.

Note that in FIG. 3, the lateral pressure PDR of the driving pulley 42b is lower than the lateral pressure PDN of the driven pulley 42a. However, in an actual driving state of the vehicle 14, PDR is mostly higher than PDN.

Such stopping and starting of the second pump 30 are performed in accordance with the vehicle state of the vehicle 14, that is, the change in pulley pressure along with the shift operation of the transmission 12. In this case, if the motor 32 is stopped, the second pump 30 is stopped and the check valve 44 is opened. Then, the first pump 20 starts to supply the first oil to the continuously variable transmission mechanism 42 through the check valve 44. On the other hand, if the motor 32 is started, the second pump 30 is started and the discharge of the second oil is started. Then, the check valve 44 is closed due to the pressure of the second oil, and the second pump 30 starts to supply the second oil to the continuously variable transmission mechanism 42.

However, if the supply of the first oil and the supply of the second oil to the continuously variable transmission mechanism 42 are alternately switched, the stopping and the starting of the motor 32 are repeated and an overshoot often occurs in the rotation of the second pump 30. The overshoot itself cannot be controlled by the driver 34 side and the motor 32 side. Therefore, the operation of the pulley is affected by the variation of the line pressure PH and the pulley pressure due to the overshoot; thus, there is a concern that the state of the vehicle may change. In addition, there is a concern that a rush current may occur due to the overshoot, and the rush current may flow to an electronic circuit included in the driver 34. Therefore, it is preferable that the number of times that the motor 32 is started be reduced as much as possible.

### <2.2 Transition of Control State for Second Pump 30>

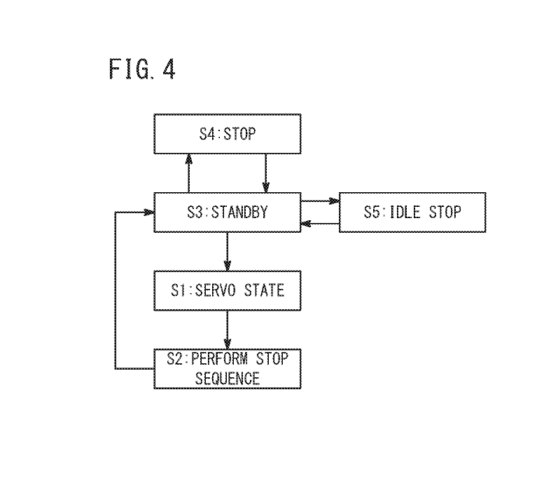

Before description of a solution to the above problem, a control method for the second pump 30 is described with reference to FIG. 4.

FIG. 4 is a state transition diagram expressing a transition of the control state for the second pump 30 in the hydraulic control device 10 in FIG. 1. The hydraulic control device 10 basically controls the second pump 30 in accordance with the state transition diagram in FIG. 4. Note that the operation of the state transition diagram is performed mainly by supplying control signals from the motor controller 28e to the driver 34.

In a servo state in step S1, the motor controller 28e supplies a control signal to the driver 34 and the driver 34 drives the motor 32 on the basis of the control signal to rotate the second pump 30. Thus, the second oil that is discharged from the second pump 30 is supplied to the continuously variable transmission mechanism 42 through the oil passage 40.

As a result, the driving torque of the first pump 20 is reduced; thus, the fuel efficiency of the vehicle 14 can be improved. That is to say, the servo state in step S1 is a state where both the first pump 20 and the second pump 30 operate and the fuel efficiency of the vehicle 14 can be improved. The process in the servo state is performed when an operation point of the second pump 30 is in the range of the discharging capability of the second pump 30.

When the servo state is stopped in step S1, the motor controller 28e performs a stop sequence in step S2. In this case, the motor controller 28e supplies to the driver 34, a control signal based on the command value Nepo that would not cause a sudden drop of the line pressure PH (an oil pressure drop). Then, the driver 34 drives the motor 32 on the basis of the control signal to decrease the rotation number Nem of the motor 32 and the rotation number Nep (Nepr) of the second pump 30, while avoiding the occurrence of oil pressure drop, so as to make the transition to a standby state in step S3.

In the standby state in step S3, the second pump 30 is driven in the low-rotation state and the first pump 20 supplies the first oil to the continuously variable transmission mechanism 42 through the check valve 44. The process in the standby state is performed when the effect of cutting the workload of the first pump 20 is not expected even if the process in the servo state in step S1 is performed, when the fuel cut for the engine 16 is currently being performed, or when the control state is a driving state of the vehicle 14 or a transient state that does not correspond to step S1, S2, S4, or S5.

In this case, the motor controller 28e makes the transition from the standby state in step S3 to the above-described servo state in step S1, the stop state in step S4, or the idle stop state in step S5, on the basis of the state of the vehicle or the like.

The stop state in step S4 is a state in which the operation (starting) of the second pump 30 is not permitted, that is, the second pump 30 is stopped. Specifically, the control state is shifted to step S4 when the oil temperature To is in a low temperature state or a high temperature state or when the vehicle 14 includes a failed part or a malfunctioning part.

The idle stop state in step S5 is a state where the second pump 30 is driven while the vehicle 14 is not idling. Specifically, the state of step S5 is realized in a time band from when idling is stopped at the request of idle stop or at the time of the vehicle speed V becoming zero, until the engine 16 explodes completely (sustains continued rotation).

Therefore, the motor controller 28e shifts the control state for the second pump 30 in the directions of arrows illustrated in FIG. 4 in accordance with various conditions of the vehicle, such as the vehicle speed V, the engine rotation number New, the oil temperature To, and the lateral pressure.

### <2.3 Solution to Above Problem>

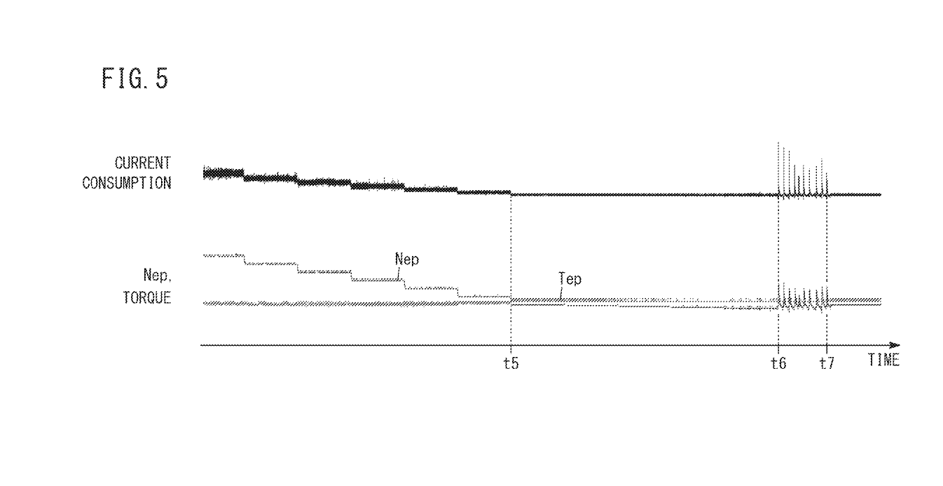

Next, description is given concerning the methods to solve the above problem with reference to FIG. 5 to FIG. 9.

### (2.3.1 First Method)

In a first method, if the oil temperature To is in a predetermined temperature range and the pressure (the line pressure PH, the lateral pressure PDN) of the oil supplied to the continuously variable transmission mechanism 42 is more than or equal to a predetermined pressure, the pump operation decision unit 28d permits the motor 32 to start.

FIG. 5 shows a test result that demonstrates a control limit of the second pump 30 when the second pump 30 is rotated in the low-rotation state.

In this test, if the rotation number Nep is decreased step by step as time elapses to reduce current consumption, the current consumption stops falling in a time band between a time point t5 and a time point t6. Thus, the second pump 30 can be stably rotated at the rotation number Nep that is low. Therefore, if the rotation number Nep that is low is set as the command rotation number for the second pump 30, the second pump 30 can be optimally controlled.

On the other hand, in a time band between the time point t6 and a time point t7 where the rotation number Nep of the second pump 30 is further decreased, the rotation number Nep and the current consumption pulsate; thus, the second pump 30 cannot be controlled properly. This is because of the following reason: the motor 32 cannot control to maintain the low-rotation state due to the decrease of the rotation number Nep and repeats stopping and starting; thus, hunting, that is, repeated opening and closing of the check valve 44, occurs. Due to the hunting of the rotation of the motor 32, the flow rate of the second oil varies and the line pressure PH pulsates. Therefore, when the second pump 30 is simply shifted to the low-rotation state, the current is largely consumed at the starting; thus, the power consumption of the motor 32 and the second pump 30 increases.

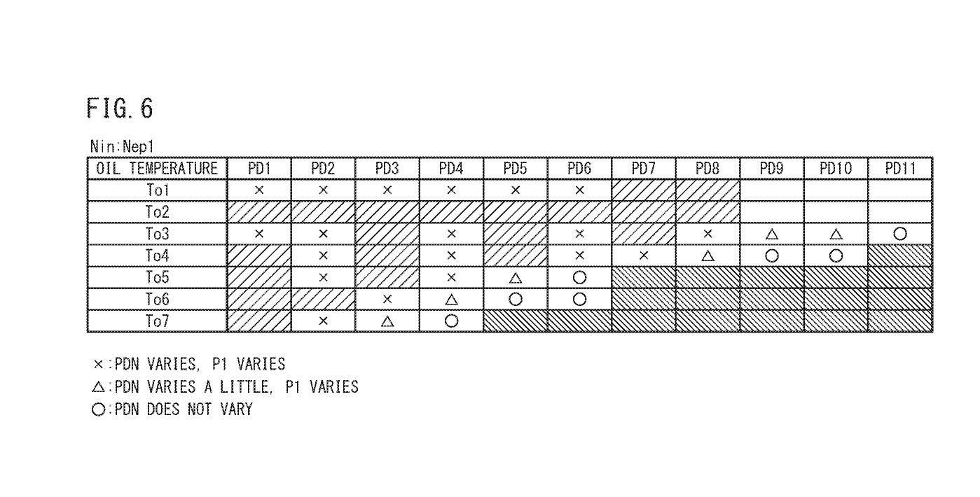

FIG. 6 to FIG. 8 are tables expressing the results of examination as to whether the lateral pressure PDN and the output pressure P1 vary when the oil temperature To and the lateral pressure PDN are changed at arbitrary rotation numbers Nep (Nep1<Nep2<Nep3). In these tables, the oil temperature To satisfies To1<To2< . . . <To6<To7, and the lateral pressure PDN satisfies PD1<PD2< . . . <PD10<PD11.

In these tables, a circular mark indicates a case where the lateral pressure PDN did not vary. A triangle mark indicates a case where the lateral pressure PDN varied a little and the output pressure P1 varied. A cross mark indicates a case where both the lateral pressure PDN and the output pressure P1 varied. Note that a sparsely hatched region indicates that the measurement was not performed but the mark is estimated to be the cross mark. On the other hand, a densely hatched region indicates that the measurement was not performed but the mark is estimated to be the circular mark. A blank region indicates other ranges.

In this test, since PDN is more than PDR, the lateral pressure PDN varies. On the other hand, if PDN is less than PDR, the lateral pressure PDR varies.

As illustrated in FIG. 6 to FIG. 8, if the oil temperature To is low, the necessary flow rate Q (leak amount) described below is small; thus, the hydraulic pulsation with low sensitivity becomes large with the increase of the flow rate due to the overshoot that occurs in the rotation of the motor 32 (see FIG. 5). In addition, if the oil temperature To is low, the lateral pressure PDN and the output pressure P1 are easily affected by the overshoot.

Thus, as the first method, on the basis of the results in FIG. 6 to FIG. 8, if the oil temperature To is in a predetermined temperature range and the lateral pressure PDN (the line pressure PH in accordance with the lateral pressure PDN) is more than or equal to a predetermined pressure, the pump operation decision unit 28d permits the second pump 30 (the motor 32 that drives the second pump 30) to start. Specifically, in the regions with the circular marks or the dense hatching shown in FIG. 6 to FIG. 8, the starting of the motor 32 is permitted.

### (2.3.2 Second Method)

In a second method, if the servo state in step S1 is switched to the standby state in step S3 in FIG. 4 and the motor 32 (the second pump 30) is rotated in the low-rotation state, the standby rotation number Nepi of the second pump 30 based on the current oil temperature To is extracted with reference to the table 28f, and the motor 32 is rotated on the basis of the extracted standby rotation number Nepi.

That is to say, in the second method, on the basis of the results in FIG. 6 to FIG. 8, the standby rotation number Nepi of the second pump 30 is changed depending on the value of the oil temperature To as illustrated in FIG. 2. Therefore, in the standby state in step S3 in FIG. 4, if the second pump 30 is driven in the low-rotation state, the pump operation decision unit 28d decides the standby rotation number Nepi based on the current oil temperature To with reference to the table 28f. The motor controller 28e supplies to the driver 34, a control signal based on the standby rotation number Nepi that is decided by the pump operation decision unit 28d. Thus, in the standby state where the first oil is supplied from the first pump 20 to the continuously variable transmission mechanism 42 through the check valve 44, the driver 34 drives the motor 32 in accordance with the control signal; therefore, the second pump 30 can be rotated at the standby rotation number Nepi.

### (2.3.3 Third Method)

In a third method, in a circumstance where the influence of the overshoot on the pressure (the line pressure PH, the pulley pressure) of the oil supplied to the continuously variable transmission mechanism 42 is small, the motor 32 is started. The third method is applied when the control state is shifted from the stop state in step S4 to the standby state in step S3.

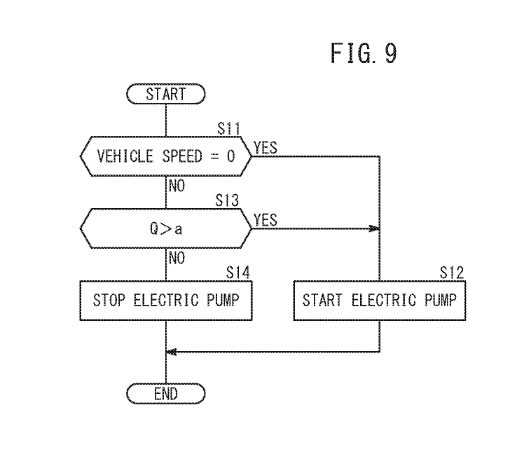

Specifically, description is given with reference to the flowchart in FIG. 9.

When the second pump 30 is in the stop state, the vehicle speed determination unit 28b determines whether the vehicle speed V is zero in step S11. If V is zero, that is, if the vehicle 14 is in the stop state (step S11: YES), the process advances to step S12. In step S12, the pump operation decision unit 28d permits the second pump 30 to start in response to the positive determination result in step S11.

In response to the permission decision by the pump operation decision unit 28d, the motor controller 28e supplies to the driver 34, the control signal to start the motor 32. The driver 34 starts the motor 32 on the basis of the control signal that is supplied to drive the second pump 30. In this case, an overshoot occurs in the rotation of the motor 32 and an overshoot also occurs in the rotation number Nep of the second pump 30; thus, the pressure of the second oil (the line pressure PH, the pulley pressure) varies. Note that the processing is performed when the vehicle 14 is in the stop state, and so the variation of the line pressure PH and the pulley pressure does not affect the state of the travel of the vehicle 14.

If the vehicle 14 is traveling (step S11: NO), the process advances to step S13. In step S13, on the basis of the gear ratio between the driven pulley 42a and the driving pulley 42b and the leak amount of control parts of the hydraulic control device 10 (each part of the hydraulic system that supplies oil to the continuously variable transmission mechanism 42), the flow rate determination unit 28c calculates the necessary flow rate Q, and determines whether the necessary flow rate Q that is calculated is more than the threshold a. If the necessary flow rate Q is more than the threshold a (step S13: YES), the process advances to step S12.

In step S12, the pump operation decision unit 28d permits the second pump 30 to start in response to the positive determination result in step S13, and in response to the permission decision by the pump operation decision unit 28d, the motor controller 28e supplies to the driver 34, the control signal to start the motor 32. The driver 34 starts the motor 32 on the basis of the control signal that is supplied, so that the driving of the second pump 30 is started.

In this case, an overshoot occurs in the rotation number Nem of the motor 32 and the rotation number Nep of the second pump 30, but, if the necessary flow rate Q is more than the threshold a, a large amount of first oil is supplied from the first pump 20 to the continuously variable transmission mechanism 42 through the check valve 44 like in the shift operation in the transmission 12. Therefore, even if the amount of discharge of the second oil temporarily increases due to the overshoot, the influence of the overshoot on the line pressure PH and the pulley pressure is small.

On the other hand, if the determination result in step S13 is negative (step S13: NO), the pump operation decision unit 28d does not permit the second pump 30 to start in step S14, and in response to the non-permission decision by the pump operation decision unit 28d, the motor controller 28e maintains the stop state of the motor 32 and the second pump 30.

### [3. Effect of the Present Embodiment]

As described above, in the hydraulic control device 10 according to the present embodiment, when the motor 32 is in the low-rotation state and the supply of the first oil from the first pump 20 to the continuously variable transmission mechanism 42 through the check valve 44 is switched to the supply of the second oil from the second pump 30 to the continuously variable transmission mechanism 42, the motor 32 is shifted from the low-rotation state to a high-rotation state. Thus, the occurrence of the overshoot can be prevented.

On the other hand, in a circumstance where the motor 32 should be stopped, the motor 32 is started only when the influence of the overshoot is small. Thus, the influence of the overshoot can be minimized.

Therefore, in the present embodiment, in either of the case where the rotation number Nem of the motor 32 is decreased and the case where the motor 32 is stopped, the number of times that the second pump 30 is started can be reduced as much as possible and the change of the vehicle state and the generation of a rush current can be avoided.

If the second pump 30 is rotated in the low-rotation state, the motor controller 28e controls the motor 32 so that the second pump 30 is rotated at the standby rotation number Nepi based on the oil temperature To in the table 28f.

Thus, when the second pump 30 is in the low-rotation state, the hunting, that is, opening and closing of the check valve 44 due to the second oil discharged from the second pump 30, can be prevented. As a result, the unintended increase of the power consumption of the motor 32 and the second pump 30 due to the hunting can be avoided.

Since the pump operation decision unit 28d permits the motor 32 to start, the occurrence of overshoot can be prevented effectively.

When the vehicle 14 including the transmission 12 is in the stop state or the flow rate of the first oil supplied from the first pump 20 to the continuously variable transmission mechanism 42 through the check valve 44 is more than the flow rate of the second oil supplied from the second pump 30 to the continuously variable transmission mechanism 42 like in the shift operation in the vehicle 14, the second pump 30 is started. Thus, the influence of overshoot can be minimized.

As described above, in the present embodiment, the number of times the second pump 30 is started can be reduced. For example, when the control state is shifted from the standby state in step S3 to the servo state in step S1, the second pump 30 may be started only once during the start of the engine 16 if starting the second pump 30 does not lead to any particular problem. By providing the standby state in step S3, the power consumption can be reduced. In addition, when the second pump 30 is started, the change of the state of the vehicle due to, e.g., the occurrence of pulsation of the second oil, is avoided; therefore, abnormal shift in the continuously variable transmission mechanism 42 can be prevented.

The present invention is not limited to the above embodiment and may employ various structures on the basis of the description in the present specification.

What is claimed is:

1. A hydraulic control device including, between a first pump and a hydraulic operation unit of a transmission, a second pump driven by a motor and a check valve connected in parallel and configured to supply first oil from the first pump to the hydraulic operation unit through the check valve, or pressurize the first oil that is supplied from the first pump with the second pump and supply the first oil that has been pressurized to the hydraulic operation unit as second oil, the hydraulic control device comprising a motor controller configured to decrease a rotation number of the motor or stop the motor when supply of the second oil from the second pump to the hydraulic operation unit is switched to supply of the first oil from the first pump to the hydraulic operation unit through the check valve,
wherein the motor controller is configured to, in a case where an overshoot occurs in a rotation of the motor when the motor in a stop state is started, start the motor only in a circumstance where an influence of the overshoot on a pressure of oil that is supplied to the hydraulic operation unit is small.

2. The hydraulic control device according to claim 1, further comprising a temperature acquisition unit configured to acquire a temperature of the first oil or the second oil, and a table configured to express a relation between a standby rotation number that is a rotation number after being decreased and the temperature,
wherein the motor controller is configured to set the standby rotation number based on the temperature with reference to the table and decrease the rotation number of the motor to the standby rotation number.

3. The hydraulic control device according to claim 2, further comprising a start permission determination unit configured to permit the motor to start if the temperature is in a predetermined temperature range and the pressure of the oil that is supplied to the hydraulic operation unit is more than or equal to a predetermined pressure.

4. The hydraulic control device according to claim 1, wherein the circumstance where the influence of the overshoot is small is a circumstance where a vehicle including the transmission is in the stop state or a circumstance where a flow rate of the first oil supplied from the first pump to the hydraulic operation unit through the check valve is more than a flow rate of the second oil supplied from the second pump to the hydraulic operation unit.
